(19) United States
(12) Patent Application Publication
(10) Pub. No.: US 2009/0062988 A1
(43) Pub. Date: Mar. 5, 2009

(54) Safety Device for a Motor Vehicle Having at Least One Closable Opening to the Interior

(75) Inventors: Hans-Herbert Schreier, Ueberlingen (DE); Ulrich Tschaeschke, Ehningen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/663,343

(22) PCT Filed: Sep. 20, 2005
(86) PCT No.: PCT/EP2005/010106

§ 371 Date: Oct. 28, 2008

(30) Foreign Application Priority Data
Sep. 22, 2004 (DE) 10 2004 045 820.0

(51) Int. Cl. B60R 21/013

(52) U.S. Cl. 701/45; 180/281

(57) ABSTRACT

A safety device is provided for a motor vehicle having at least one closable opening to the interior, with a closing element that is driven by an electric adjusting drive. A control unit evaluates data which are relevant for driving safety for an imminent accident and actuates the electric adjusting drive to initiate a rapid closing process for the closing element in an overcurrent mode thereof, before the accident actually occurs.

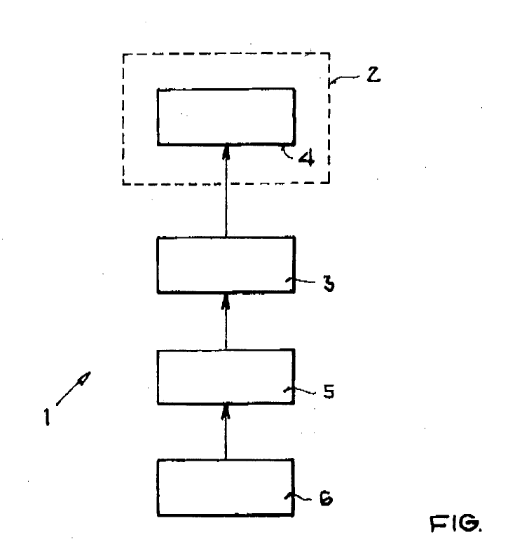

### BACKGROUND AND SUMMARY OF THE INVENTION

This application is a national stage of PCT International Application No. PCT/EP2005/010106, filed Sep. 20, 2005, which claims priority under 35 U.S.C. § 119 to German Patent Application No. 10 2004 045 820.0, filed Sep. 22, 2004, the disclosure of which is expressly incorporated by reference herein.

The invention relates to a safety device for a motor vehicle having at least one closable opening to the interior.

German patent document DE 40 31 552 A1 discloses a safety device for a vehicle whose interior has at least one opening (for example, a side window or a roof opening), which can optionally be at least partially closed or released by a closing element which is coupled to an adjusting drive. A sensor system detects deceleration of the vehicle in the driving direction and, when a prespecified value for deceleration of the vehicle is exceeded, triggers the closing movement of the closing element. Given a suitable selection of the prespecified value for deceleration of the vehicle, the opening may already be closed even before the motor vehicle hits the obstacle. When an actual accident occurs, the vehicle occupants are protected against injury by foreign bodies which enter the vehicle through the opening from the outside. It is also possible to prevent vehicle occupants from being thrown through the opening.

In addition, an energy storage device which is designed as a spring store is provided as the energy source, which causes a rapid closing movement of the closing element when activated. The design of the energy storage device has proven to be mechanically complex, cost-intensive and requires a corresponding installation volume. Realization of the energy storage device is associated with considerable expense.

German patent document DE 101 21 386 C1 describes a method for actuating a reversible occupant protection arrangement in a motor vehicle using a sensor system which detects driving state data. Instances of emergency braking, oversteer and understeer of the motor vehicle are monitored as driving state data. The occupant protection arrangement is triggered as a function of such a state. In addition, the direction from which the greatest danger can be expected can be determined from the driving state data. The occupant protection arrangement is actuated in such a way that protective action is taken in accordance with the direction of greatest danger.

In addition, German patent document DE 44 11 184 C2 discloses a restraint belt system for a seat in a vehicle, having a seat belt and a belt tensioner for securing a passenger on the seat. An apparatus is used to determine the distance to an object and the corresponding relative speed. This information can be used to determine the expected time until the possible collision between the vehicle and the object. A control unit generates a control signal which increases the force of the belt tensioner in good time before the possible collision. If a collision can be avoided, the force of the belt tensioner is again reduced. The controllable belt tensioner is designed as a pretensioner which is active only up to a prespecified pretension before the collision, with a further belt tensioner for tightening the seatbelt more tautly being triggered if the collision actually takes place.

One object of the invention is to provide a safety device for a motor vehicle having at least one closable opening of an interior of the motor vehicle, with a closing element which is driven by an adjusting drive being provided for closing the opening, which safety device provides optimum occupant protection compared to the safety devices known from the prior art.

This and other objects and advantages are achieved by the safety device according to the invention, which includes a control unit that evaluates data that are relevant for driving safety for an imminent accident, and actuates the electric adjusting drive such that a rapid closing process is initiated for the closing element, in an overcurrent mode of the electric adjusting drive, before the accident event occurs.

The safety device comprises at least one closable opening of a motor vehicle interior, with the closing element which is driven by the electric adjusting drive being provided for closing the opening. The rapid closing process is initiated in an overcurrent mode for the closing element even, before the actual accident occurs, so that additional safety is achieved for the occupants. A closing operation which is accelerated in comparison with normal operation for movement of the closing element is carried out in good time.

In a normal mode, the closing element is driven at a prespecified current intensity which does not lead to overload operation of the electric adjusting drive for the closing element. In the case of the existing rapid closing operation, the electric adjusting drive is operated in the overcurrent mode for a short time period, which leads to brief overload operation. Such operation, however, does not adversely affect the functional operation of the electric adjusting drive, due to the short duration and low frequency of its operation.

In this case, it is desirable for the opening to be closed before an anticipated accident occurs. As a result, an occupant can be prevented from unintentionally exiting the vehicle through the closable opening during the course of the actual accident event, and no foreign bodies can enter the motor vehicle from the outside. (In addition, it might otherwise no longer be possible to move the closing element to a closed position during the actual course of the accident under certain circumstances on account of the voltage supply failing or the vehicle body being deformed.) The time immediately preceding the accident is already used to initiate precautionary measures for improving occupant safety. Preventive occupant protection is ensured by the preventatively acting safety device. The closing element may be any automatically closable opening of the motor vehicle, for example a window pane or a sliding roof, in particular a sliding roof with an additional lifting function.

In one refinement of the invention, the closing element is moved to a prespecified position before an anticipated accident actually occurs. In the prespecified position the closable opening has an open gap, which is preset for each vehicle series. This results in two advantages. Firstly, trapping protection is realized. The closable opening is not completely closed by the rapid closing operation, so that it is possible to avoid an occupant's limbs becoming trapped as a result of the closing operation, which takes place rapidly and is associated with considerable exertion of force, due to the occupant possibly failing to react. Depending on the design of the safety device, the remaining open gap can then be closed in a normal mode of the adjusting drive during which the occupant can better sense possible trapping, and has more time to react. The gap can be closed immediately after the rapid closing operation.

Sufficient ventilation of the interior for the occupants of the motor vehicle can be ensured via the open gap when an accident occurs in the event of the opening not being completely rapidly closed. A large amount of gas and soot particles which could present a health risk for the occupants can be produced in the event of an accident as a result of, for example, pyrotechnic occupant protection means being triggered. The gas and soot particles can escape from the interior of the motor vehicle to the surroundings and, at the same time, oxygen can be supplied from the outside to the occupants in the interior through the opening which is open to the width of a gap and may, for example, be a side window. In this case, it is advantageous if the closing element can be moved to the prespecified position both from an open and from the closed position.

Data which are relevant for driving safety may comprise, in particular, driving state variables, such as vehicle speed, yaw rate, longitudinal acceleration and lateral acceleration, brake pedal position and accelerator pedal position, and steering angle. Furthermore, the status of operator control elements, such as indicators and hazard warning lights, and the status of sensors and controllers which relate to the motor vehicle can be used as driving state variables.

As an alternative or in addition, the data which are relevant for driving safety can comprise data about the surroundings, which is provided by sensors for the surroundings, telematics systems and communication between the motor vehicle in question and other motor vehicles and stationary communications systems. Examples of data about the surroundings include information about the current location, category of road and lane in which the vehicle is traveling. Other examples of data about the surroundings include, inter alia, road states, temperature, weather, light conditions and speed, distance, type and size of motor vehicles and other road users traveling in front of, adjacent to, behind and in the opposite direction to the motor vehicle in question.

It is also advantageous if the data relevant to driving safety comprises evaluated driver activities. Detection of the driver activity includes, for example, not only identifying eye movement and the viewing direction but also the operator control processes of operator control elements (such as steering wheel, gear selector lever and brake pedal). By evaluating a plurality of items of safety-relevant data, it is possible to use the control unit to determine, if necessary, the correct time to close the closing element.

Other objects, advantages and novel features of the present invention will become apparent from the following detailed description of the invention when considered in conjunction with the accompanying drawings.

### BRIEF DESCRIPTION OF THE DRAWINGS

The single FIGURE is a block diagram of a detail of a safety device for a motor vehicle provided with at least one closable opening of the interior.

### DETAILED DESCRIPTION OF THE DRAWINGS

According to the FIGURE, a safety device 1 for a motor vehicle comprises a closable opening of an interior 2 of the motor vehicle, with a closing element 4 which is driven by an electric adjusting drive 3 being provided for closing the opening. The closing element 4 may, for example, be designed as a side window or as a sliding roof of the motor vehicle.

A control unit 5 evaluates the data 6 which are relevant for driving safety for an imminent accident, and actuates the electric adjusting drive 3 so that a rapid closing process is initiated for the closing element 4 in an overcurrent mode of the electric adjusting drive 3, before an expected accident actually occurs. In a refinement of the invention, the magnitude of the overcurrent is matched to a typical prewarning time in such a way that the closable opening can be closed before the accident occurs.

In a further refinement of the safety device 1, the closing element 4 can be moved before an anticipated accident actually occurs, to a specified position in which position the closable opening has an open gap. The size of the gap can be preset, for example as a function of the design of the closing element 4 or on the basis of safety-related considerations. The presetting operation can be carried out at the factory, or can be performed by an occupant of the motor vehicle. The rapid closing function of the electric adjusting drive 3, which is caused by the overcurrent mode ensures that the closing element 4 reaches its end position with the open gap in good time before the actual accident event occurs. The open gap is then closed in a normal mode of the electric adjusting drive 3, in which the occupant can better sense trapping and has more time to react. If the accident does not in fact occur, the closing element 4 is returned to its starting position again in a normal mode of the electric adjusting drive 3.

The safety device 1 may also activate a plurality of closing elements 4 in parallel, for example a plurality of side windows of the motor vehicle. The side windows may be actuated in various modes of operation. In a first mode of operation, all the window panes can be moved into a prespecified position at the same time. In a second mode of operation, only those window panes which are next to an occupant are actuated. Occupant detection can be carried out using a seat occupancy detection means. However, other modes of operation are also feasible for the safety device 1.

The data 6 that are relevant for driving safety comprise driving state variables, data about the surroundings and/or evaluated driver activities.

It is also feasible to operate other components of the motor vehicle temporarily in an overcurrent mode, particularly safety components, components of a vehicle seat and/or other comfort functions which depend on reaching a prespecified state quickly.

The inventive safety device 1 for the motor vehicle provided with the closable opening of the interior 2 guarantees the occupants of the motor vehicle that the occupant protection system will be activated rapidly and in good time, even before an anticipated accident occurs. The safety device 1 can be realized with less technical and financial outlay compared to the prior art, since the essential components of the safety device 1 are generally already integrated in the motor vehicles as standard.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-10. (canceled)

11. A safety device for a motor vehicle having at least one opening to the interior that is closeable by a closing element driven by an electric adjusting drive to close the opening, wherein a control unit evaluates data that are relevant for driving safety for an imminent accident and actuates the electric adjusting drive so that a rapid closing process is initiated for the closing element in an overcurrent mode of the electric adjusting drive before the accident event occurs.

12. The safety device as claimed in claim 11, wherein:
the closing element is moved to a prespecified position before an anticipated accident occurs; and
in said prespecified position the closable opening has an open gap.

13. The safety device as claimed in claim 12, wherein the size of the open gap can be preset.

14. The safety device as claimed in claim 12, wherein the open gap is then closed in a normal mode of the electric adjusting drive.

15. The safety device as claimed in claim 11, wherein the overcurrent has a magnitude that is matched to a typical prewarning time in such a way that the closable opening is closed before the accident event occurs.

16. The safety device as claimed in claim 11, wherein the closing element is one of a side window and a sliding roof of the motor vehicle.

17. The safety device as claimed in claim 11, wherein the data which are relevant for driving safety comprise driving state variables.

18. The safety device as claimed in claim 11, wherein the data which are relevant for driving safety comprises data that characterize vehicle surroundings.

19. The safety device as claimed in claim 11, wherein the data which are relevant for driving safety comprise evaluated driver activities.

20. The safety device as claimed in claim 11, wherein, if an anticipated accident event does not actually occur, the closing element is moved back to its original starting position in a normal mode of the electric adjusting drive.

21. A method of operating a closure member which is driven by an electric adjusting drive to close an opening of an interior space of a vehicle, said method comprising:
a control unit detecting occurrence of an operating condition of the vehicle that is indicative of an accident which is likely imminent; and
in response to detection of an occurrence of such operating condition, said control unit initiating a closing a said closure member before said accident occurs;
wherein said closing is performed by operating said electric adjusting drive at a closing speed that is greater than a closing speed of said closure member in a normal operating mode thereof, and permits said closure member to reach a predetermined position before said accident occurs.

22. The method according to claim 21, wherein said predetermined position of said closure member completely closes said opening.

23. The method according to claim 22, wherein said predetermined position leaves open a predetermined portion of said opening, in the form of a gap.

24. The safety device as claimed in claim 23, wherein the size of the open gap can be preset.

25. The safety device as claimed in claim 23, wherein the open gap is thereafter closed in a normal mode of the electric adjusting drive.

26. The method according to claim 21, wherein said step of detecting occurrence of an operating condition comprises detecting data that characterize at least one of driving state variables for the vehicle, vehicle surrounds and driver actions.

27. Apparatus for operating a closure member for closing an opening of an interior space of a vehicle, said apparatus comprising:
an electric adjusting drive for moving said closure member between open and closed positions; and
a control unit which controls operation of said adjusting drive; wherein,
said control unit detects occurrence of an operating condition of the vehicle that is indicative of an accident which is likely imminent; and
in response to detection of an occurrence of such operating condition, said control unit initiates a closing of said closure member before said accident occurs;
said closing is performed by operating said electric adjusting drive at a closing speed that is greater than a closing speed of said closure member in a normal operating mode thereof, and permits said closure member to reach a predetermined position before said accident occurs.

28. The apparatus according to claim 27, wherein said predetermined position is said closed position.

29. The apparatus according to claim 27, wherein said predetermined position is intermediate said open and closed positions, leaving an opening in the form of a gap.

30. The apparatus according to claim 27, wherein said control unit detects occurrence of said operating condition by evaluating data that characterize at least one of driving state variables for the vehicle, vehicle surroundings and driver actions.
